(19) United States
(12) Patent Application Publication
(10) Pub. No.: US 2007/0139039 A1
(43) Pub. Date: Jun. 21, 2007

(54) Stick position sensor and replacement process

(76) Inventor: Klaus Manfred Steinich, Zorneding (DE)

Correspondence Address: HEAD, JOHNSON & KACHIGIAN, 228 W 17TH PLACE, TULSA, OK, 74119, US

(21) Appl. No.: 11/641,172

(22) Filed: Dec. 19, 2006

(30) Foreign Application Priority Data
Dec. 19, 2005 (DE) 102005060674.1

(51) Int. Cl. G01B 7/14

(52) U.S. Cl. 324/207.11

(57) ABSTRACT

Position sensors in stick design for installation. e.g. in hydraulic cylinders, can be maintained and replaced without leakage, with the sensor head housing having a attachable and detachable dome- and cap shaped sensor head cover, which can be opened without removing the remaining housing out of the piston cylinder unit, opening the access to the functional components of the sensor.

### CROSS-REFERENCE TO RELATED APPLICATIONS

This application claims priority to Germany Patent Application No. 102005060674.1 filed 19 Dec. 2005.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The invention regards position sensors in stick form according to a non-contacting functional principle for application in fluids, among other things. Position sensors in stick form measure the position of a position indicator fastened to a component moveable relative to the stick position sensor.

Such sensors are used, among other things, in an interior of hydraulic or pneumatic cylinders in order to know the exact extension of the piston/cylinder unit at any time. This is of great importance for control of the machinery and equipment operated therewith.

The position sensor is thereby located in a tight housing which comprises a long, slender sensor-stick-housing and a connected, shorter sensor sensor-head-housing which has a larger diameter and wherein processing electronics are located.

Thereby, the sensor with its sensor-head-housing is located in the piston/cylinder unit in a longitudinal fixed manner so that the slender sensor-stick-housing extends into a typically central bore of the piston or piston rod where the position indicator is mounted.

The current position of the piston rod relative to the cylinder is known at any time since the sensor-stick-housing, and thereby the measuring length of the sensor, extend along the entire possible extension length of the piston rod.

Thereby, the housing of the sensor at its exterior side is in direct contact with operating fluid of the piston/cylinder unit and is exposed to its operating pressure. Especially in hydraulic units with very high pressures, it is of great importance that the sensor housing is provided stable enough and tight and that a sufficient sealing is provided between the housing of the sensor and the piston/cylinder unit, mostly through a respective seal at the exterior circumference of the sensor-head-housing relative to a surrounding wall of the pneumatic or hydraulic cylinder.

As a non-contacting sensor principle thereby differential transformatoric measuring procedures (LVDT's), non-contacting inductive measuring procedures (LVD's), inductive potentiometric measuring procedures (RVDT-sensors), Eddy current procedures and often also magnetic functional principles are being used. With the latter ones, a permanent magnet is being used as a position indicator, with other processes a tube sleeve, a submerged anchor, or a similar component. With PLLD-sensors, through a magnet, a virtual air gap is being created in a ferromagnetic core, which determines the position. Furthermore, magnetostrictive measurement procedures can be advantageously used for this.

As it is well known magnetostrictive position sensors function as follows:

Typically, a wave conductor is made of a tube, a wire, or a band and can also serve as an electric conductor. The wave conductor can also be located in a shape generating linear or circular body made from non-magnetic material e.g. plastic or metal, for receiving the wave conductor and holding it in bearings.

Based on the Wiedemann-Effect an electric impulse fed into the wave conductor generates a mechanic elastic wave when superimposed with a position magnet.

At a certain location, typically at one end of the wave conductor in particular the torsion component, the mechanic/elastic impulse is detected by a detector unit frequently located in a fixed position relative to the wave conductor. The duration between triggering of the electrical excitation impulse and the reception of this mechanic elastic wave thereby is a measure for the distance of the slideable position element, e.g. of the position magnet, of the detection device.

A typical such sensor is described in the U.S. Pat. Nos. 5,590,091 and 5,736,855.

Subsequently, only magnetostrictive position sensors are referred to without limiting the invention to this position measurement principle.

There are several problem areas in such position sensors used in piston/cylinder units.

Repairs constitute another problem area.

A failure of the piston sensor can occur due to the described, often high operating pressures in such piston/cylinder units, and rough operating environments like strong vibrations, etc. as they often occur in equipment. The piston sensor may need to be replaced completely, or components of it, possibly a part of the processing electronics or of the wave conductor unit of the magnetostrictive sensor.

Since especially due to the above mentioned operating conditions, the processing electronics in the sensor-head-housing of the sensor were generally solidly encased. In this case, the piston/cylinder unit had to be opened and the whole position sensor with its housing had to be removed from the piston/cylinder unit, until presently.

This means that before removing the sensor, the operating fluid in the respective piston/cylinder unit has to have ambient pressure, since otherwise large amounts of operating fluid exits into the environment and the connected actuators change positions unintentionally.

On the other hand, after replacing the position sensor, the respective piston/cylinder unit or the whole operating loop to which it is connected may have to be refilled or at least bled, which entails a considerable effort and poses an additional source for failures if performed incorrectly.

### BRIEF SUMMARY OF THE INVENTION

Therefore, it is an object of the present invention to provide a stick-shaped position sensor according to the magnetostrictive operating principle which can be exchanged in a piston/cylinder unit without leakage, that is, without opening the loop of an operating fluid.

Through providing a tight cover, in particular a one-piece sensor-head-cover on a sensor-head-housing facing away from the sensor-stick-housing which can be removed easily and quickly after removing the sensor head cover, the functional components of the position sensor can be reached and extracted completely without having to remove the housing of the sensor from its installed position.

In this context, easy disassembly means primarily disengaging a positively locking connection, such as a thread, a snap ring or a similar component, and in particular not disassembling a connection which is not meant to be disassembled, like a glue joint, an encasement, a weld, a solder joint, or similar, though thereby under certain circumstances the cover would not be destroyed, but the respective connection area.

The same sensor-head-cover can be used again if it can be disassembled and reassembled without destruction.

Thereby, it is possible to leave the housing of the position sensor in its sealed assembly position in a piston/cylinder unit while the position components of the position sensor are tested, repaired, or replaced. Therefore, draining of the operating medium and a subsequent pressurization and bleeding is not necessary so that work on the sensor can be performed much quicker.

Even all functional components of the sensor can be replaced this way, thus the whole position sensor besides its outer housing. Replacing the sensor housing itself is rarely necessary, since the housing is typically stable enough so that it is not damaged during normal operation.

In order for removal of the functional components and also of the sensor-head-cover to be performed with as few problems as possible, an extraction in axial direction towards the side facing away from the sensor-stick-housing is provided.

Preferably, a cable exit will be provided preferably central and extending in axial direction in the cap of a dome. Since an interior diameter of the dome is selected as large as possible, on the exterior side no sufficient radial free space is available between the exterior circumference of the dome and the outside contour of the head housing.

The cable outlet can be inserted through a connector socket or a cable pass-through, e.g. a cable grommet inserted into a bore of the outer wall, or also through an interior thread fabricated into this bore, whose diameter is sized relative to the outer diameter of the cable to be passed through so that the core diameter of the interior thread is smaller than the exterior diameter of the insulation of the cable but larger than the interior diameter of the cable, and thus the cable insulation is threaded into the interior thread and fixed in longitudinal direction.

The housing of the sensor is fixed in the surrounding unit, e.g. the piston/cylinder unit, through a thread and is sealed with a seal. The thread is located either at the outer circumference of the sensor-head-housing, or at the outer circumference of the sensor-stick-housing in the section adjacent to the sensor-head-housing, preferably in the section with a diameter slightly enlarged relative to the sensor-stick-housing. The seal is thereby located on the side of the thread opposite to the sensor-stick-housing in order not to be able to damage the seal through contact with the internal thread of the surrounding component.

In order to be able to tighten the thread sufficiently, the outer circumference of the sensor-head-housing is partially provided as an external hexagonal shape for applying an opened end wrench.

In order to protect the processing electronics against strong vibrations while still being able to replace the processing electronics and/or the wave conductor unit without having to open the tight installation of the housing of the position sensor in the surrounding assembly group, inside the sensor-head-housing an inside dish, opened towards the sensor head cover e.g. made from plastic can be provided, inside which the processing electronics are located and encased relative to the interior dish. Through precise reception of the interior dish in the sensor-head-housing and of the signal connections, e.g. plug connections or threaded connections of the processing electronics, on the one hand, towards the wave conductor unit, and, on the other hand, towards the cable exit, the possibly encased electronics can be replaced as a separate component after disconnecting the signal wires, and after removing the unit consisting of the processing electronics and the interior dish, also the wave conductor unit located behind it can be extracted.

The cover for closing the head housing can furthermore be used for performing error diagnosis and/or programming of the processing electronics located in the interior of the head housing in a simple manner.

Thus, the processing electronics in the interior of the head housing can include a light source, e.g. emitting only light of a certain wave length, e.g. a LED or an infrared unit.

When the cover is made of a material such as plastic which is permeable to all light or at least to light of this special wave length, an optical signal emitted by the light source located in the interior of the head housing, e.g. a flash rhythm, can be detected from outside in a non-contacting manner, and/or versa, wherein in the interior of the head housing a respective sensor is located and externally the respective light source is located.

A simple solution is to provide an opening in the cover at the location of the light source through which the light source and the optical signal are visible. However, the housing is not tight anymore. This is avoided through a sight window installed in a tight manner.

The cover preferably has a flange with hexagonal circumference and equal dimensions as the head housing which is bolted to the head housing at three or six locations, and thereby, can be fixed in several defined rotational positions relative to the head housing.

From the head housing in the direction of the cover, a preferably circumferential flange protrudes, reaching into the dome of the attached cover precisely centering it in lateral direction. The processing electronics are provided on printed circuit boards which are preferably inserted or fixed in longitudinal direction in opposing grooves of the interior dish, which can be made from plastic.

The interior dish does not have to be a dish which is closed in circumferential direction but lateral lobes extending from the bottom of the dish in axial direction from the stick housing are heretofore sufficient, which are located on two opposing sides, and which have matching grooves on the inside for receiving the printed circuit boards, preferably several pairs of grooves.

Since this interior dish is connected to the cover in a solid manner, e.g. bolted, through removing the cover also the entire processing electronics together with the interior dish can be removed from the sensor.

Therefore, the bottom of the dish can be bolted to the cap of the dome of the cover, or also at the frontal free end of the lateral lobes, a fixation of these lateral lobes relative to the cap of the dome can be provided.

In order to center also the interior dish itself relative to the head housing in lateral direction, the interior dish has a central protrusion pointing in the direction of the stick housing which fits into a respective indentation in the bottom of the head housing.

When the sensor carrier unit wherein a longitudinal scale, among other things, is located, like e.g. the wave conductor, is also mounted to the dish housing in a solid manner, through removing the cover the complete sensor unit with all functional components can be removed from the sensor housing or can be replaced with another functioning unit.

### BRIEF DESCRIPTION OF THE DRAWINGS

Embodiments according to the invention are subsequently described in more detail in an exemplary manner.

FIGS. 1a and 1b show a position sensor according to the invention in a side view and in an axial face view from the sensor-head-housing.

FIGS. 2a through 2g show an enlarged detailed illustration of the head area of another embodiment of the sensor.

FIGS. 3a through 3d show detail views of the present invention.

FIGS. 4a and 4b show another embodiment similar to FIG. 2.

FIGS. 5a through 5c show another embodiment similar to FIG. 2.

### DETAILED DESCRIPTION OF THE INVENTION

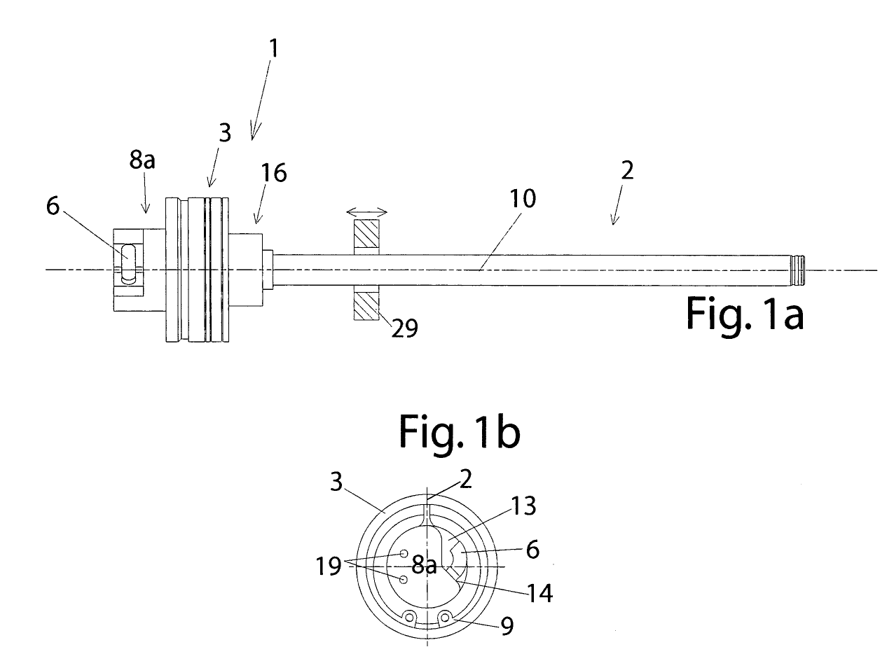

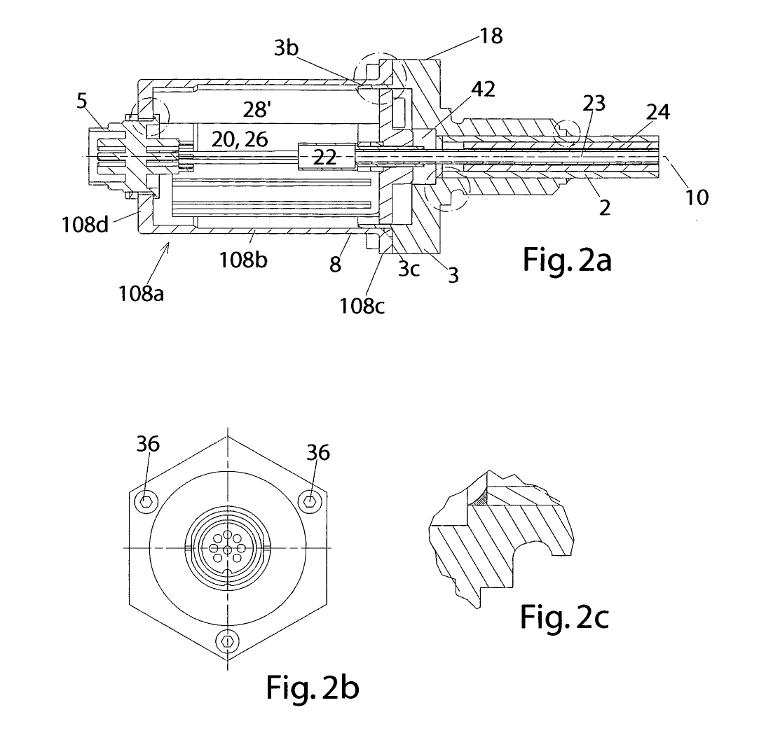

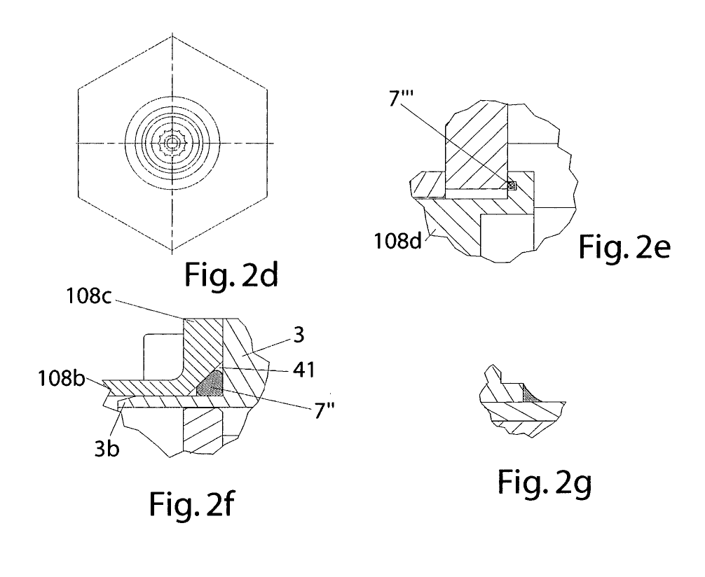

FIG. 1a shows in a side view a position sensor 1, e.g. a magnetostrictive. In an interior of a sensor-stick-housing 2, extending in longitudinal direction 10, a measuring device is located. Therein extends a wave conductor unit 24 with a central wave conductor 23 visible only in the sectional view of the FIG. 2 and the following figures.

At the left end of sensor-stick-housing 2, a sensor-head-housing 3 is connected in a tight manner having an external diameter 12 several times larger than a diameter of sensor-stick-housing 2 but only has a fraction of its length. At a transition to sensor-stick-housing 2, sensor-head-housing 3 comprises an area 16 with an enlarged diameter relative to the sensor-stick-housing 2, however, significantly smaller than the largest diameter 12 of the otherwise cylindrical sensor-head-housing 3, which is dish-shaped, thus opened towards a front side facing away from sensor-stick-housing 2.

Since sensor-stick-housing 2 is closed tight at the right end facing away from sensor-head-housing 3, e.g. through an end cap, thus, the whole housing of the position sensor is opened towards the left end in the FIGS. 1 and 2, and closed there through a one-piece sensor head cover 8 having a central dome 108a protruding beyond an open face of sensor-head-housing 3 towards the left in FIGS. 1 and 2.

Along sensor-stick-housing 2 an annular position magnet 29 is moved in a radial distance and thereby without contacting. The position of the magnet in longitudinal direction 10 is to be measured by position sensor 1.

FIG. 1b shows the top view in longitudinal direction from the side of the cover, in which besides a radial indentation 13 with a cable exit 4 and a cable 6 in its flat area 14, and in which it is also recognizable that cover 8 reaches into the interior circumference of sensor-head-housing 3 and is secured there through a snap ring 9. Also, two light indicators 19 can be seen in this front face.

Contrary to this, FIGS. 2 show an embodiment in which cover 8 abuts with its flange to front face 3c of sensor-head-housing 3 and is bolted to it through longitudinal threaded bolt connections 36 extending through pass-through bores of the flange.

An outer edge 108c of flange of cover 8 is thereby shaped hexagonal analogous an external hexagonal shape 18 of sensor-head-housing 3.

An interior space in sensor-head-housing 3 for processing electronics 20, shown only schematically in FIG. 2, is thereby preferably provided through the much larger dome 108a of cover 8, which is larger in axial direction 10, and also in radial direction.

Sensor-head-housing 3, on the other hand, is mostly made of a massive plate, perpendicular to the longitudinal direction 10 with outer hexagonal shape 18 as a circumference from whose outer rim, receded to the inside, a flange 3b protrudes to a side facing away from sensor-head-housing 2, abutting on the inside of a side wall 108b with a dome 108a, thereby centering cover 8 when the cover 8 is attached.

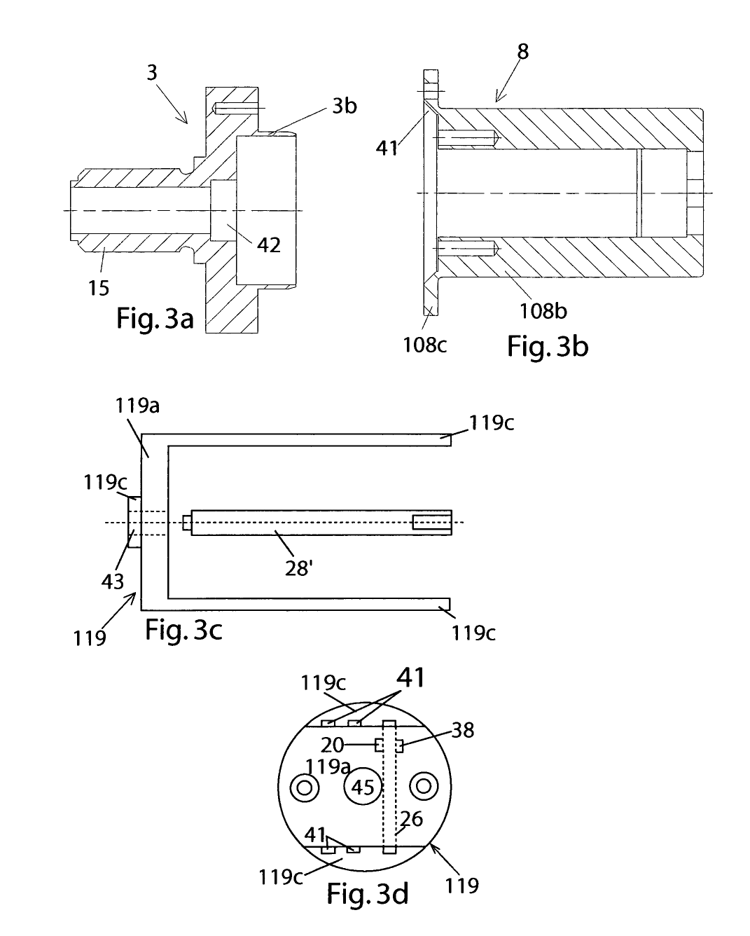

Furthermore, a bottom of sensor-head-housing 3 has a central round indentation 42 which is open from sensor-stick-housing 2 into an opposite direction, as can be seen best in the detailed illustration of sensor-head-housing 3 in FIG. 3a.

Processing electronics 20 are located on lateral printed circuit boards 26 which are held through an interior dish 119, shown as a single component in FIGS. 3c and 3d (side view and top view) in the interior of sensor-head-housing 3.

As FIG. 3c and FIG. 3d show best, interior dish 119 comprises a dish bottom 119a from which, in the direction of cap 8d of the dome 108a, two plate-shaped protrusions 119c protrude, located on opposite sides.

In the interior surfaces of these protrusions 119c, three opposing grooves 41 are located into which the respective printed circuit boards 26 can be inserted with their outer edges in longitudinal direction.

At the opposite side, the bottom of dish 119a has a protrusion 119c fitting into indentation 42 of sensor-head-housing 3 so that over a flange 3b, cover 8 and through indentation 42, interior dish 119 is centered in sensor head housing 3.

In order to mount interior dish 119 including processing electronics 20 and preferably the whole sensor unit with all functional parts to cover 8 as a unit that can be handled in its entirety, interior dish 119 can be bolted down via spacer sleeves 28′ from its bottom 119a against a cap 108d of cover 8, for which in bottom 119a two threaded holes are located in the area between protrusions 119c.

Alternatively, according to FIG. 3b, a side wall 108b in the dome of cover 8 can be provided thick enough so that openings can be provided in the housing at least at two opposite locations. The openings open from the flange side with a thread for bolting to sensor-head-housing 3. In this embodiment separate spacer sleeves 28′ can be left out.

A sensor carrier unit 24, wherein wave conductor 23 is centrally located, extends through a central opening 43 in bottom 119a of dish 119 into an interior of sensor-head-housing 3 and is connected with dish 119 in a solid manner and carries sensor element 22 at its rear end, which is connected with processing electronics 20.

Through extracting cover 8, shown as a single component in FIG. 3b, the whole sensor unit with all functional elements can be removed from the housing and replaced.

Through sealing cover 8 and placing it onto sensor-head-housing 3, the complete sensor unit is received tight in the housing.

FIG. 2f shows a detailed view of a manner of sealing a flange 108c relative to sensor-head-housing

An interior circumferential edge at an intersection of flange 108c and side wall 108b of cover 8 is beveled so that in the non-beveled internally circumferential abutting shoulder of sensor-head-housing 3 an annular circumferential free space 41 with triangular cross-section remains.

As can be seen in FIG. 2f, in free space 41 a seal 7″, preferably an O-ring made from elastic material, is located and sized so that it gets compressed during axial abutment of cover 8 at a respective shoulder of the head housing 3 in free space 41, thereby imparting axial and radial forces onto cover 8a. Thereby, the penetration is avoided of dirt or water into the interior space of sensor-head-housing 3 towards the processing electronics, wherein the strength of the seal depends on the degree of compression and of the elasticity of seal 7″.

In the same manner, also interior dish 119 can be secured in sensor-head-housing 3 in a rotationally fixed manner.

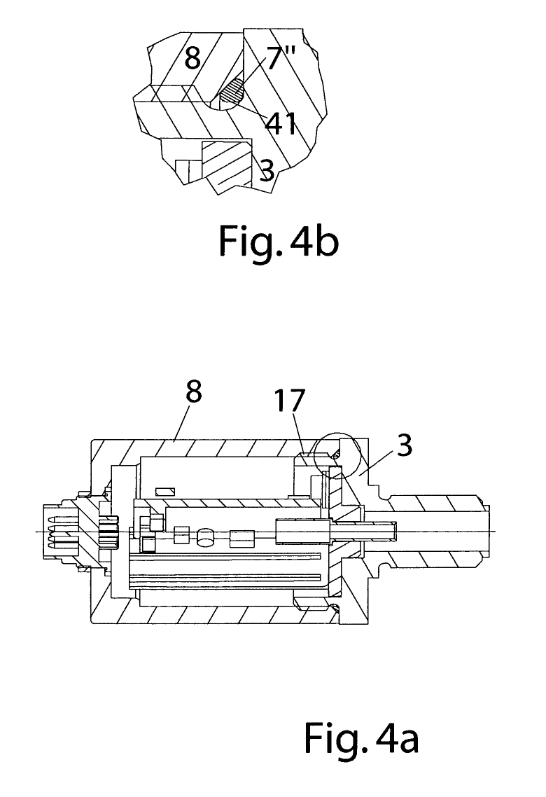

The same kind of seal between cover 8 and sensor-head-housing 3 through an O-ring wedged in triangular free space 41 is shown in FIGS. 4a and 4b, however, on an outside of the flange 3b of sensor-head-housing 3, an external thread 17 is located onto which cap-shaped cover 8 is threaded with a respective interior thread until it sufficiently compresses the O-ring 7”.

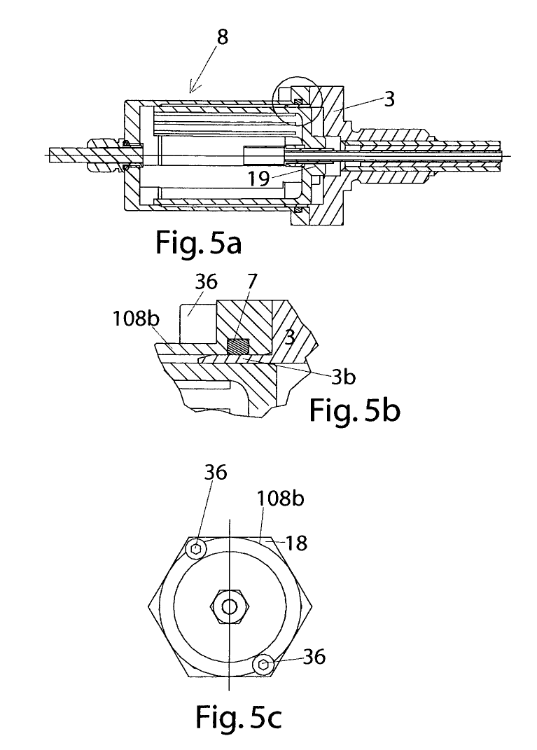

On the other hand, FIG. 5 shows a mounting and sealing of cover 8 relative to sensor-head-housing 3 wherein a cap-shaped cover 8 is placed onto sensor-head-housing 3 and fixed through a bolt connection 36, wherein, however, longitudinal bolts extend through opposing indentations open towards an outside in a round outer edge 108c of the flange of cover 8.

The seal is performed, e.g. via an O-ring as seal 7 which is located in a groove in an interior circumference of a wall 108b, radially open to the inside and abutting against an outer circumference of flange 3b of sensor head housing 3.

FIG. 2e shows in an enlarged depiction, furthermore, a seal of a connector socket 5 centrally located in a cap 108d of cover 8, through a seal 7′ abutting to an inside of cap 108d in an axially open groove of connector socket 5.

The single component view of sensor-head-housing 3 in FIG. 3a furthermore shows a thread 15 located on an outside of a section 16 facing away from flange 3b in the direction of sensor-stick-housing 2.

As the assembly drawing of FIG. 2a shows, tubular sensor-stick-housing 2 in this area 16 of sensor-head-housing 3 is inserted almost up to indentation 42 and welded on its inside to a free front face of sensor-stick-housing 2 and also to an outside of the free front face of this section 16 carrying the thread 15.

What is claimed is:

1. A position sensor (1) in an enclosed stick design for use in fluids according to a non-contacting magnetic functional principle, said sensor comprising:
a sensor-stick-housing (2) connected to a sensor-head-housing (3) and tightly connected in a sensor housing;
a sensor unit having sensor functional components being located in the sensor-head-housing;
processing electronics (20) or a connection element to the outside being located in the sensor-head-housing (3);
a cable running out of the sensor-head-housing (3) through a cable exit (4) or a connector socket (5);
a circumferential seal (7) on an outside of the sensor-head-housing (3) and/or the sensor-stick-housing (2);
the sensor head housing (3) including a sensor head cover (8) that can be quickly and simply removed so that the functional components of the sensor cannot be damaged through removal; and
the sensor head cover being located and sized so that after its removal the sensor unit is accessible for repair or partial or complete replacement.

2. A position sensor according to claim 1 wherein said sensor-head-housing (3) has a sensor head cover (8) located on a side of said circumferential seal (7) facing away from said sensor-stick-housing (2) and which can be removed and reattached without getting damaged.

3. A position sensor according to claim 1 wherein said sensor head cover (8) can be removed through disengaging a positively locking connection.

4. A position sensor according to claim 1 wherein at least said sensor head cover (8) with the complete or partial processing electronics (20) can be pulled off from said sensor head housing (3) in an axial manner from a side pointing away from said sensor stick housing (2).

5. A position sensor according to claim 1 wherein after opening said sensor-head-cover (8), the whole sensor unit, with all sensor functional components, can be extracted out of said sensor-head-housing as one unit in an axial manner on a front side of said sensor-head-housing (3) pointing away from said sensor-stick-housing, whereby said sensor unit forms a connected unit together with said sensor head cover (8).

6. A position sensor according to claim 1 wherein said sensor unit is connected with said head sensor cover (8) in a detachable manner.

7. A position sensor according to claim 1 wherein said sensor head cover (8) abuts to a front face of said sensor-head-housing (3) pointing away from said sensor-stick-housing (2) and is radially centered through a flange (3b) protruding from said sensor-head-housing (3).

8. A position sensor (1) in an enclosed stick design for use in fluids according to a non-contacting, magnetic functional principle, said sensor comprising:
a sensor stick housing (2), which is connected to a sensor head housing (3) to form a tight connected sensor housing;
a sensor unit with all sensor functional components located in the sensor housing;
processing electronics (20), or a connection element to the outside are housed in the sensor housing (3);
a cable running out from the sensor head housing (3) through a cable outlet (4) or a connector socket (5);
an axial or radial circumferential seal (7) on an outside of the sensor head housing (3) and/or the sensor stick housing (2);
a sensor cover (8) closing the sensor head housing (3) on a front face pointing away from the stick housing (2) and being provided with a cap shaped with a dome (108a), axially to the outside, which is hollow with a smaller diameter than an outside diameter (12) of the sensor head housing (3).

9. A position sensor according to claim 8 wherein said cable outlet (4) is a bore with an interior thread whose core diameter is smaller than an exterior diameter of insulation of said cable (6), threaded therein.

10. A position sensor according to claim 8 wherein an O-ring is compressed in a free space with triangular cross-section which is formed through the two components to be sealed relative to each other.

11. A position sensor according to claim 8 wherein at an outer circumference of said sensor-stick-housing (2) a thread (15) is provided in a section (16) having an enlarged diameter relative to said sensor-stick-housing (2), directly abutting to said sensor head housing (3).

12. A position sensor according to claim 8 wherein an outer circumference of said sensor-head-housing (3) is provided at least over a part of an axial extension as an exterior hexagonal shape (18) for applying an open-end wrench.

13. A position sensor according to claim 8 wherein in said sensor-head-housing (3) an interior dish (119) is located, open towards said sensor head cover, wherein said processing electronics (20) are housed and sealed tight and where the interior dish (119) can be removed from said sensor-head-housing (3).

14. A position sensor according to claim 8 wherein a signal connection between a detector unit (22) at a wave conductor (23) and said processing electronics (20), possibly located also outside of the housing (2, 3), can be decoupled, is plug connected, or provided in a non-contacting manner, e.g. via radio or infrared.

15. A position sensor according to claim 8 wherein said sensor head cover (8) is made from plastic that is permeable for light at least of a certain wave length.

16. A position sensor according to claim 8 wherein within said sensor-head-housing (3) at least one light indicator is located and in said sensor head cover (8) a LED opening (39), through which the LED is visible, and the LED (38) and the LED opening (39) are located in a center of a base and interior cross-section (17).

17. A position sensor according to claim 8 wherein in an interior of said sensor-head-housing (3) an infrared unit (40), a transmitter and receiver unit is located, including an infrared source and/or a infrared sensor, used for programming and/or diagnosis of the sensor.

18. A position sensor according to claim 8 wherein a dome (108a) has an axial extension which is larger than an axial extension of said sensor-head-housing (3), and an interior space of the dome (108a) amounts to at least 80% of an entire interior space of said sensor-head-housing (3).

19. A position sensor according to claim 8 wherein said sensor head cover (8) is bolted in axial direction to a face of said sensor-head-housing (3) and has a same outer contour as said head housing (3).

20. A position sensor according to claim 8 wherein an interior dish (119) has side pieces (119b) opposing each other on two sides, protruding from a dish bottom (119a) in an axial direction facing away from said sensor-stick-housing (2), wherein in axial direction, grooves (41) towards an inside are provided for inserting one or several printed circuit boards (26) on which said process electronics (20) are located.

21. A position sensor according to claim 8 wherein an interior dish (119) has a particularly central protrusion (119c), which protrudes in longitudinal direction (10) in a direction of said sensor-stick-housing (2), and in a bottom of said sensor-head-housing (3) a corresponding indentation is provided.

22. A position sensor according to claim 8 wherein an interior dish (119) is bolted to said sensor head cover (8), through a dish bottom (119a) being bolted to an upper side of a dome (108a) through spacer sleeves (28′).

23. A process for replacing the functional component of a stick position sensor (1) installed into a piston cylinder unit (30), whose sensor stick housing (2) reaches into the operating fluid (31) of the unit (30), said process comprising the following steps:
clearing a front face of a sensor-head-housing (3) facing away from a sensor-stick-housing (2) through removal of possibly present components covering the front face at piston cylinder unit (30),
disengaging a fixed cover;
lifting the sensor head cover (8) from the sensor head housing (3); and
repairing or replacing a defective functional component from the side facing away from the sensor stick housing (2).

24. The process according to claim 23 wherein during partial replacement/repair of processing electronics (20), a remainder of the processing electronics (20) during the repair/replacement remains at the sensor head housing (3).

25. The process according to claim 24 wherein during repair/replacement of a component of the processing electronics (20), the signal conductor from the processing electronics (20) to the detector unit (22) is disengaged, and the connection to the connector socket (5) or the cable (6), and the whole processing electronics (20), in particular together with the interior dish, (119) is replaced.

26. The process according to claim 24 wherein during repair/replacement of a part of the sensor unit, the entire processing electronics (20) is preliminarily removed from the sensor head housing (3) and the functional components are removed from the sensor stick housing (2) and repaired or replaced and reinstalled.

27. The process according to claim 24 wherein during replacement/repair of a functional component of the position sensor (1), the entire sensor unit, with all sensor functional components, connected to a functional unit together with the cover (8) is extracted from the sensor (1) through the cover (8) and an analogue new functional unit is inserted.
